(19) United States
(12) Patent Application Publication
(10) Pub. No.: US 2026/0304374 A1
(43) Pub. Date: Oct. 1, 2026

(54) FEMTOCELL LOCATION BINDING

(71) Applicant: RAKUTEN MOBILE, INC., Tokyo (JP)

(72) Inventors: Pawan KUMAR, Tokyo (JP); Vishal ARORA, Tokyo (JP)

(73) Assignee: RAKUTEN MOBILE, INC., Tokyo (JP)

(21) Appl. No.: 19/097,137

(22) Filed: Apr. 1, 2025

(51) Int. Cl. H04W 64/00; H04W 48/08

(52) U.S. Cl. CPC H04W 64/003; H04W 48/08

(57) ABSTRACT

Example embodiments of the present disclosure relate to femtocell location binding. According to example embodiments, a method may include receiving, by an operation support system (OSS), a MAC address and neighboring (NB) cell information from a distributed unit (DU); determining, by the OSS, whether the received MAC address matches a previous MAC address of the DU; determining, by the OSS, whether the received NB cell information matches a previous NB cell information of the DU based on determining whether the received MAC address matches the previous MAC address of the DU; and outputting, by the OSS, a location binding status for the DU based on determining whether the received NB cell information matches the previous NB cell information.

### TECHNICAL FIELD

The present disclosure relates to femtocell location binding.

### BACKGROUND

The information disclosed in this background section is only for the enhancement of understanding of the general background of the disclosure and should not be taken as an acknowledgement or any form of suggestion that this information forms the prior art already known to a person skilled in the art.

A femtocell is a small, low-power cellular base station designed for indoor use, enhancing cellular coverage and signal quality in areas with weak or limited cellular connectivity, typically within homes or small businesses. The user may connect to a mobile network (provided by the mobile network operator) using the femtocell to provide a broadband internet connection, and the user may connect their mobile devices to the femtocell to access the internet connection.

In the related art, location binding is a feature used to verify the location of the provided femtocell. For example, the femtocell may have a customer address, and if the user changes the physical location of the femtocell, the services provided by the femtocell should be disabled until the user initiates a change of address operation. The femtocell may be associated with a particular MAC address, and have neighbor (NB) information of neighboring cells of the femtocell.

### SUMMARY

In the related art, there is an issue with location binding if the user changes the physical location of the femtocell (e.g., moving from one city to another), without changing the setup of the femtocell and the broadband router, without informing the mobile network operator of the address change. In this scenario, the MAC address of the femtocell would remain the same, even though the NB information has changed, while the femtocell is still operational. This may be a serious violation according to telecommunication regulations, because the femtocell should be locked out of cell operation in this scenario.

Accordingly, there is a need for a way to enhance the logic behind location binding for femtocells to handle edge cases and make location binding more efficient.

According to example embodiments, a method may be provided, including receiving, by an operation support system (OSS), a MAC address and neighboring (NB) cell information from a distributed unit (DU); determining, by the OSS, whether the received MAC address matches a previous MAC address of the DU; determining, by the OSS, whether the received NB cell information matches a previous NB cell information of the DU based on determining whether the received MAC address matches the previous MAC address of the DU; and outputting, by the OSS, a location binding status for the DU based on determining whether the received NB cell information matches the previous NB cell information.

Based on example embodiments, edge cases for location binding of the femtocell can be considered, and accuracy of the location binding feature is increased such that cases which would violate telecommunications regulations are avoided, particularly the case wherein the location of the end-user is changed while the femtocell configuration is the same, without informing the mobile network operator.

According to example embodiments, an operation support system (OSS) may be provided and configured to: receive a MAC address and neighboring (NB) cell information from a distributed unit (DU); determine whether the received MAC address matches a previous MAC address of the DU; determine whether the received NB cell information matches a previous NB cell information of the DU based on determining whether the received MAC address matches the previous MAC address of the DU; and output a location binding status for the DU based on determining whether the received NB cell information matches the previous NB cell information.

According to example embodiments, a non-transitory computer-readable recording medium having recorded thereon instructions executable to perform a method may be provided, the method including: receiving, by an operation support system (OSS), a MAC address and neighboring (NB) cell information from a distributed unit (DU); determining, by the OSS, whether the received MAC address matches a previous MAC address of the DU; determining, by the OSS, whether the received NB cell information matches a previous NB cell information of the DU based on determining whether the received MAC address matches the previous MAC address of the DU; and outputting, by the OSS, a location binding status for the DU based on determining whether the received NB cell information matches the previous NB cell information.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a block diagram of an example system architecture for a femtocell in a passive optical network, according to one or more example embodiments;

FIG. 2 illustrates a logic table for location binding status, according to one or more example embodiments;

FIG. 3 illustrates a flowchart for determining location binding status based on MAC address and neighbor cell information, according to one or more example embodiments;

FIG. 4 illustrates a block diagram of an example method for determining location binding status, according to one or more example embodiments;

FIG. 5 illustrates a block diagram of an example device for implementing one or more example embodiments; and

FIG. 6 illustrates a block diagram of an example environment for implementing one or more example embodiments.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

It shall be noted that, descriptions of example embodiments of the present disclosure may include terms and names defined in one or more standard organizations, such as the 3rd Generation Partnership Project (3GPP) standard organization, the European Telecommunications Standards Institute (ETSI) standard organization, the Open Radio Access Network (O-RAN) Alliance standard organization, and the like.

Example embodiments provide an enhanced location binding feature for femtocell networks. In particular, additional edge cases which involve the neighboring cell information of a given femtocell/optical network unit (ONU) being empty/no information either pre or post operation can be considered.

According to example embodiments, a method may be provided. The method may include receiving, by an operation support system (OSS), a MAC address and neighboring (NB) cell information from a distributed unit (DU); determining, by the OSS, whether the received MAC address matches a previous MAC address of the DU; determining, by the OSS, whether the received NB cell information matches a previous NB cell information of the DU based on determining whether the received MAC address matches the previous MAC address of the DU; and outputting, by the OSS, a location binding status for the DU based on determining whether the received NB cell information matches the previous NB cell information.

Based on example embodiments, edge cases for location binding of the femtocell can be considered, and accuracy of the location binding feature is increased such that cases which would violate telecommunications regulations are avoided, particularly the case wherein the location of the end-user is changed while the femtocell configuration is the same, without informing the mobile network operator.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of the example embodiments of the present disclosure are provided in the following.

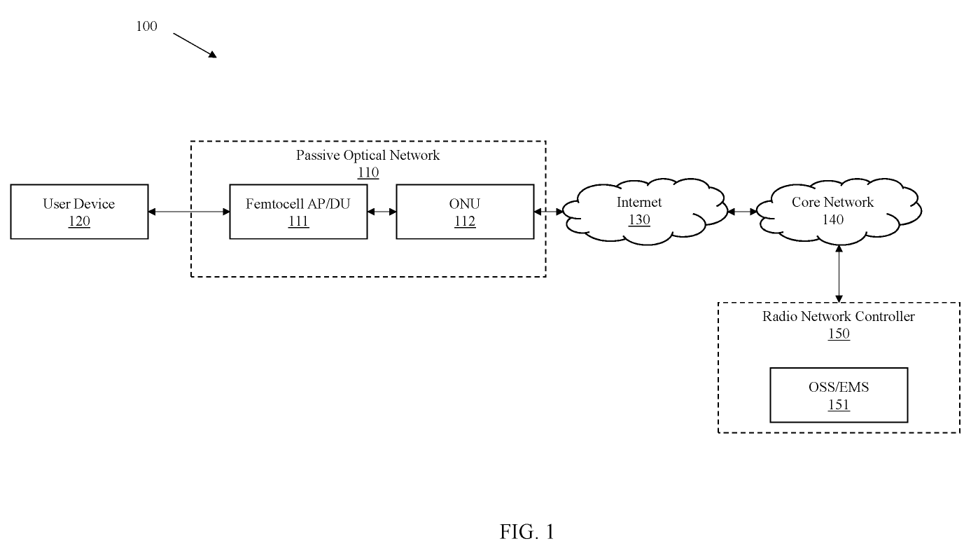

FIG. 1 illustrates a block diagram of an example system architecture for a femtocell in a passive optical network, according to one or more example embodiments.

Referring to FIG. 1, system 100 may be provided, which may include passive optical network (PON) 110, user device 120, internet 130, core network 140, and radio network controller 150.

PON 110 may include a femtocell access point (AP)/distributed unit (DU) 111 which is interconnected with an Optical Network Unit (ONU) 112. The user device 120 may connect with Femtocell AP/DU 111 to access internet 130. ONU 112 may be responsible for providing broadband access to internet 130. According to embodiments, ONU 112 may be connected to a series of passive optical splitters, which may be connected to an Optical Line Terminal (OLT), as part of PON 110 (not illustrated in FIG. 1). The specific configuration of PON 110 may depend on the implementation thereof.

The mobile network operator may operate mobile network in core network 140. Core network 140 may be managed using a radio network controller 150. Radio network controller (RNC) 150 may implement services such as Operation Support System (OSS)/Element Management Services (EMS) 151 for managing aspects of core network 140.

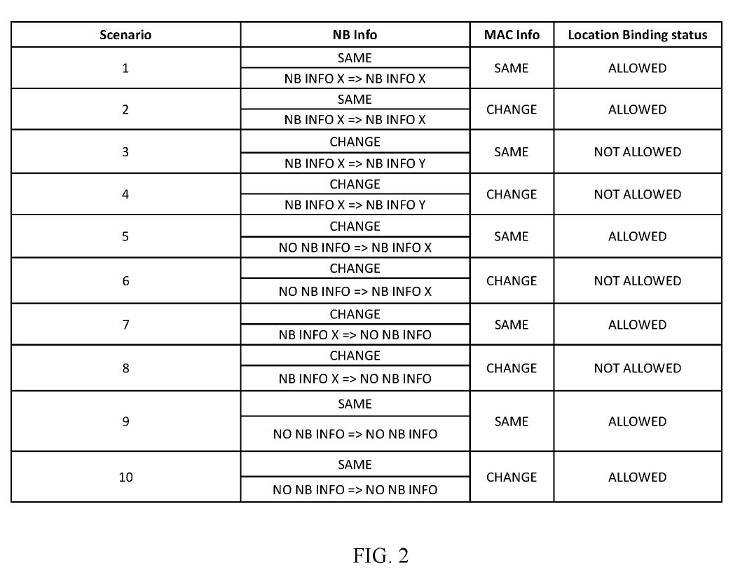

FIG. 2 illustrates a logic table for location binding status, according to one or more example embodiments. Ten example scenarios are described, based on the status of the neighbor (NB) cell information and the MAC information of the given ONU, the resulting location binding status may be given. According to embodiments, the MAC address and the NB information for the given ONU may be received by the OSS (e.g., OSS 151) of the radio network controller (e.g., RNC 150). Previous (pre) information of the given ONU may be stored (for example, in a database).

In scenario 1, the NB information remains the same, and the MAC address remains the same. Accordingly, location binding status is allowed, since there was no change in location.

In scenario 2, the NB information remains the same, and the MAC address has changed. Accordingly, location binding is allowed, since there was no change in location.

In scenario 3, the NB information has changed from X to Y, whereas the MAC address has not been changed. Accordingly, location binding is not allowed, since there was a change in location

In scenario 4, the NB information has changed from X to Y, and so has the MAC address. Accordingly, similar to scenario 3, location binding is not allowed, since there was a change in location.

In scenario 5, the NB information has changed from having no information, to having some information, whereas the MAC address is the same. Accordingly, location binding is allowed since it is possible for the femtocell to go from having no NB info to having some NB info if the MAC address didn’t change.

In scenario 6, the NB information has changed from having no information, to having some information, however the MAC address changes. Accordingly, since there was a change in MAC address whereas there was no NB info previously, location binding is not allowed.

In scenario 7, the NB information has changed from having some information, to no information, wherein the MAC address remains the same. Location binding may be allowed, for similar reasoning with scenario 5.

In scenario 8, the NB information has changed from having some information, to no information, however the MAC address has changed. Location binding may be not allowed, for similar reasoning with scenario 6.

In scenario 9, there is no NB information both pre and post, and the MAC address remains the same. Location binding may be allowed for this scenario.

In scenario 10, there is no NB information both pre and post, and the MAC address changes. Location binding may also be allowed for this scenario.

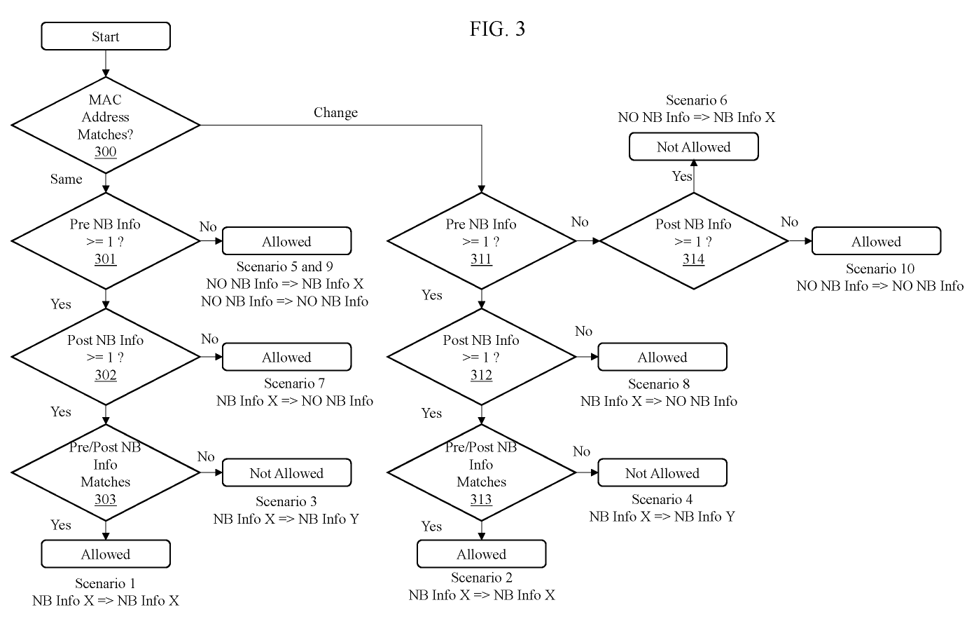

FIG. 3 illustrates a flowchart for determining location binding status based on MAC address and neighbor cell information, according to one or more example embodiments.

Starting from operation S300, the system may firstly determine whether a previous MAC address and a current MAC address of the DU are matching.

If the result of operation S300 is that the MAC addresses are the same, operations S301, S302, and S303 may be performed in order to determine whether location binding status is allowed or not, as follows:

At operation S301, it may be determined as to whether the previous NB information is greater than or equal to 1 (that is, was there any NB information previously available). If none, then location binding may be allowed (e.g., Scenario 5 from FIG. 2 wherein there is no NB information => NB information X, or Scenario 9 from FIG. 2 wherein there is no NB information => no NB information.). Otherwise, the determination may proceed to operation S302.

At operation S302, it may be determined as to whether the current (post) NB information is greater than or equal to 1 (that is, is NB information currently available). If none, then location binding may be allowed (e.g., Scenario 7 from FIG. 2 wherein NB information X => No NB information). Otherwise, the determination may proceed to operation S303.

At operation S303, it may be determined as to whether the previous NB information and the current (post) NB information matches. If no, then location binding is not allowed (e.g., Scenario 3 from FIG. 2 wherein NB information X => NB information Y). Otherwise, it may be assumed that the NB information did not change (e.g., Scenario 1 from FIG. 2 wherein NB information X => NB information X) and location binding is allowed.

If the result of operation S300 is that the MAC address changed, operations S311, S312, S313, and S314 may be performed in order to determine whether location binding status is allowed or not, as follows.

At operation S311, it may be determined as to whether the previous NB information is greater than or equal to 1 (that is, was there any NB information previously available). If none, the process proceeds to operation S314. Otherwise, it may proceed to operation S312.

At operation S312, it may be determined as to whether the current (post) NB information is greater than or equal to 1 (that is, is there any NB information currently available). If none, then location binding is allowed (e.g., Scenario 8 from FIG. 2 wherein NB information X => No NB information). Otherwise, the determination may proceed to operation S313.

At operation S313, it may be determined as to whether the previous NB information and the current (post) NB information matches. If no, then location binding is not allowed (e.g., Scenario 4 from FIG. 2 wherein NB information X => NB information Y. Otherwise, it may be assumed that the NB information did not change (e.g., Scenario 2 from FIG. 2 wherein NB information X => NB information X) and location binding is allowed.

Operation S314 continues from operation S311. At operation S314, it may be determined as to whether the current (post) NB information is greater than or equal to 1 (that is, whether there is any NB information currently available). If there is, then location binding is not allowed (e.g., Scenario 6 from FIG. 2 wherein No NB information => NB information X). Otherwise, location binding is allowed (e.g., Scenario 10 from FIG. 2 wherein No NB information => No NB information).

It should be appreciated that although the steps illustrated in FIG. 3 exemplify firstly determining as to whether the MAC information is the same or not, according to some implementations, the status of the NB information may be determined/compared first, followed by the comparison of the MAC address.

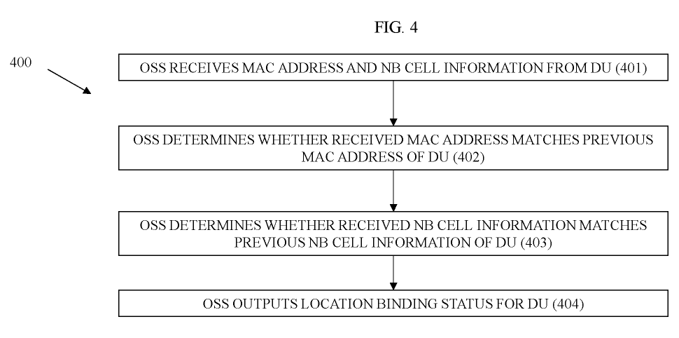

FIG. 4 illustrates a block diagram of an example method 400 for determining location binding status, according to one or more example embodiments.

Referring to FIG. 4, at operation S401, the OSS may receive a MAC address and NB cell information from the DU. This may describe the MAC address and a NB cell information of a given ONU within a PON, according to embodiments.

At operation S402, the OSS may determine whether the received MAC address from operation S401 matches a previously received MAC address of the DU. The previous MAC address may have been stored, for example, in a database.

At operation S403, the OSS may determine whether the received NB cell information matches the previous NB cell information of the DU. This may be partially based on the determination made in operation S402. The previous NB cell information of the DU may be stored, for example, in a database.

At operation S404, the OSS may output the location binding status for the DU based on the determination made in operation S403. The determination and resulting output of operations S402 through S404 may be given by the logic table exemplified in FIG. 2, and/or the flowchart illustrated in FIG. 3.

Based on the above example embodiments, edge cases for location binding of the femtocell can be considered, and accuracy of the location binding feature is increased such that cases which would violate telecommunications regulations are avoided, particularly the case wherein the location of the end-user is changed while the femtocell configuration is the same, without informing the mobile network operator.

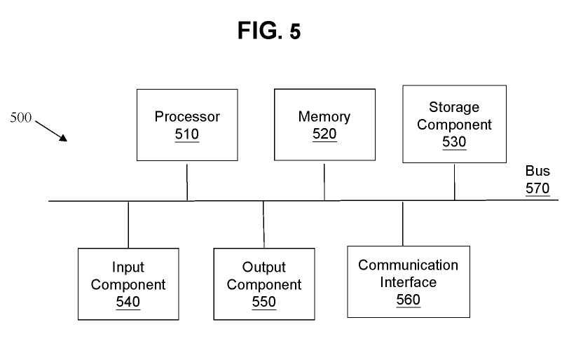

FIG. 5 illustrates a block diagram of an example device 500 for implementing one or more example embodiments. As shown in FIG. 5, the device 500 includes processor 510, a memory 520, a storage component 530, an input component 540, an output component 550, a communication interface 560, and a bus 570.

The processor 510, as used herein, means any type of computational circuit that may comprise hardware elements and software elements. The processor 510 may be embodied as a multi-core processor, a single core processor, or a combination of one or more multi-core processors and/or one or more single core processors, a distributed processing system, or the like. The processor 510 may be a Central Processing Unit (CPU), a graphics processing unit (GPU), an accelerated processing unit (APU), an application-specific integrated circuit (ASIC), or another type of processing component.

Memory 520 includes a non-transitory computer readable medium. Memory 520 includes a random-access memory (RAM), a read only memory (ROM), and/or another type of dynamic or static storage device (e.g., a flash memory, a magnetic memory, and/or an optical memory) that stores information and/or instructions for use by processor 510. The memory 520 comprises machine-readable instructions which are executable by the processor 510. These machine-readable instructions when executed by the processor 510 cause the processor 510 to perform one or more method steps of an embodiment described above.

Storage component 530 stores information and/or software related to the operation and use of the device 500. For example, storage component 530 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 540 is configured to receive information, such as user input. For example, the input component 540 may include, but not be limited to, a touch screen display, a keyboard, a keypad, a mouse, a button, a switch, and/or a microphone. Additionally, or alternatively, the input component 540 may include a sensor for sensing information (e.g., a global positioning system (GPS), an accelerometer, a gyroscope, and/or an actuator).

Output component 550 is configured to provide output information from the device 500. For example, the output component 550 may be, but not limited to, a display, a speaker, an instruction device to an external device, and/or one or more light-emitting diodes (LEDs).

Communication interface 560 is an interface that provides a communication connection to other devices, such as external devices and internal devices. The connection by the communication interface 560 can be a wired connection, a wireless connection, or a combination of wired and wireless connections, and can be a direct connection or an indirect connection via a communication network that exists between the device 500 and other devices. In other words, the standard of the communication interface 560 is not limited.

The bus 570 acts as an interconnect between the processor 510, the memory 520, the storage component 530, the input component 540, the output component 550, and the communication interface 560 of the device 500. The bus 570 may include a wired interconnection or a wireless interconnection.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500. Further, one or more method steps described in any of the embodiments may be performed utilizing a plurality of devices 500 in communication with one another.

Example embodiments of the present disclosure may be implemented in any suitable type of environment. In the following, an example environment (in which the example embodiments may be implemented) is described.

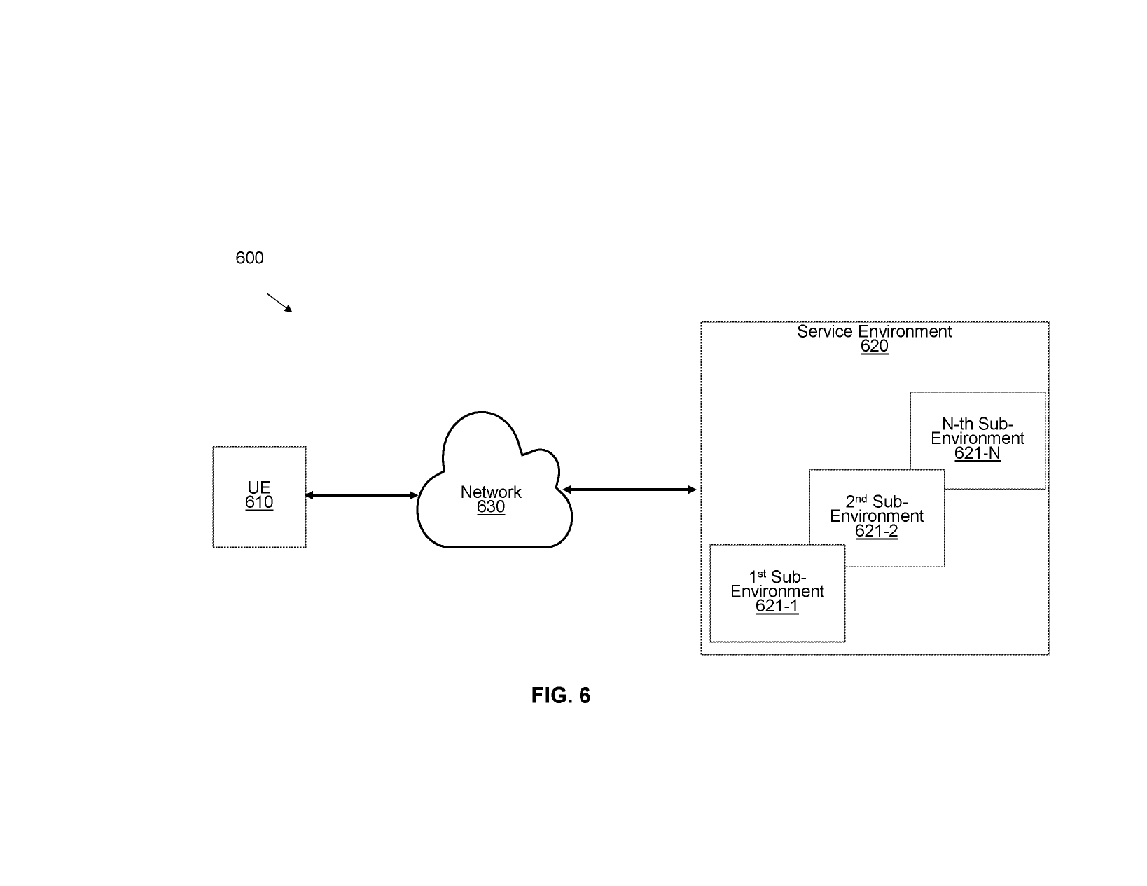

FIG. 6 illustrates a block diagram of an example environment 600 for implementing in which systems and/or method, described herein, may be implemented. The implementation environment 600 includes a UE (User equipment) 610, a service environment 620, and a network 630. The service environment 620 include one or more sub-environments 621. To illustrate this, FIG. 6 shows, for convenience, examples of a 1st sub-environment 621-1, a 2nd sub-environment 621-2, and an N-th sub-environment 621-N (where N is any natural number).

The UE 610 is connected to the network 630, and the network 630 is connected to the service environment 620. The connections may be wired, wireless, or a combination of both wired and wireless. The UE 610 and the service environment 620 are connected via the network 630.

The UE 610 is a device that communicates with the service environment 620. The UE 610 receives information from the service environment 620 and/or sends information to the service environment 620. Also, the UE 610 may generate and/or store information to be transmitted, as necessary. Also, the UE 610 may store and/or process information that is received, as necessary.

The example FIG. 6 refers to the “UE”. However, it should be understood by those skilled in the art that general terms such as “user device,” “terminal,” “terminal device,” “communication device,” and “communication terminal” can be used interchangeably with the term “UE.”

For example, the UE 610 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 620 is an environment that communicates with the UE 610 to provide one or more services. The service environment 620 receives information from the UE 610 and/or sends information to the UE 610. Also, the service environment 620 may generate and/or store information to be transmitted, as necessary. Also, the service environment 620 may store and/or process information that is received, as necessary. For example, the service environment 620 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 6 refers to the “service environment”. The term "service environment" is used to refer to the broader context within which services operate. For example, cloud environments, platforms, computing systems, network systems, and cloud systems generally represent the environments in which services are conducted, and these are included within the "service environment." However, the "service environment" is not limited to these examples. Additionally, the specific types of environments within the "service environment" are not restricted. For instance, cloud environments and cloud systems can be categorized as private cloud, public cloud, hybrid cloud, or multi-cloud, all of which are included within the "service environment."

The one or more services provided by the service environment 620 is not specifically limited and can be adjusted according to the embodiments. For example, the services may include a service that provides information to the UE 610, a service that stores information from the UE 610, or a service that performs processing based on information from the UE 610 and returns the results of the processing.

In an embodiment, the Service Environments 620 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as "Virtual" or "Virtualized" to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 620 includes one or more devices, such as servers and network devices, which provide services or perform processes. The placement of these devices within the service environment 620 can be determined as appropriate. Additionally, if the service environment 620 includes one or more sub-environments 621, the placement of devices can be determined based on predetermined policies for each sub-environment 621. For example, devices related to the first service may be placed in the 1st sub-environment 621-1, and devices related to the second service may be placed in the 2nd sub-environment 621-2. In another example, devices expected to have a higher load than a predetermined threshold may be placed in the 1st sub-environment 621-1, while devices expected to have a lower load than the predetermined threshold may be placed in the 2nd sub-environment 621-2. In this way, specific devices can be placed in specific sub-environments 621. Conversely, each sub-environment 621 can be specialized for a particular purpose.

In an embodiment, all processes executed in a single service may run within a single service environment, or in multiple service environments. Multiple processes executed in a single service could be provided by different service environments.

The network 630 is a network that exchanges information between the UE 610 and the service environment 620. The network 630 includes one or more wired and/or wireless networks.

For example, the network 630 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 630 can be a part of a network. For example, in a 5G network that includes a RAN, a transport network, and a core network, the network 630 can be at least one of the RAN, the transport network, or the core network. For example, the service environment 620 could be in the core network, in which case the network 630 could correspond to a network that is a combination of a RAN and a transport network and is part of the 5G network.

The number and arrangement of devices and networks shown in FIG. 6 are provided as an example. It should be understood that any changes that may be implemented by those skilled in the art, such as the addition or rearrangement of well-known devices or networks at the time of implementation, are included in this disclosure.

### Various Aspects of Embodiments

It is contemplated that the example embodiments described hereinabove with reference to FIG. 1 to FIG. 6 are merely examples of possible embodiments of the present disclosure, and are not intended to limit or restrict the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device (e.g., node, etc.), a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the "C" programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:

Item [1]: A method including receiving, by an operation support system (OSS), a MAC address and neighboring (NB) cell information from a distributed unit (DU); determining, by the OSS, whether the received MAC address matches a previous MAC address of the DU; determining, by the OSS, whether the received NB cell information matches a previous NB cell information of the DU based on determining whether the received MAC address matches the previous MAC address of the DU; and outputting, by the OSS, a location binding status for the DU based on determining whether the received NB cell information matches the previous NB cell information.

Item [2]: The method according to Item [1], wherein if the previous NB cell information matches the current NB cell information, the location binding status comprises enabling location binding for the DU.

Item [3]: The method according to any one of Items [1]-[2], wherein if the previous NB cell information does not match the current NB cell information, the location binding status comprises disabling location binding for the DU.

Item [4]: The method according to any one of Items [1]-[3], wherein if the received MAC address matches the previous MAC address of the DU and at least one of the previous NB cell information or the received NB cell information is empty, the location binding status comprises enabling location binding for the DU.

Item [5]: The method according to any one of Items [1]-[4], wherein if the received MAC address does not match the previous MAC address of the DU and only one of the previous NB cell information or the received NB cell information is empty, the location binding status comprises disabling location binding for the DU.

Item [6]: The method according to any one of Items [1]-[5], wherein if the received MAC address does not match the previous MAC address of the DU and both the previous NB cell information and the received NB cell information are empty, the location binding status comprises enabling location binding for the DU.

Item [7]: The method according to any one of Items [1]-[6], wherein the DU comprises a femtocell.

Item [8]: An operation support system (OSS) configured to: receive a MAC address and neighboring (NB) cell information from a distributed unit (DU); determine whether the received MAC address matches a previous MAC address of the DU; determine whether the received NB cell information matches a previous NB cell information of the DU based on determining whether the received MAC address matches the previous MAC address of the DU; and output a location binding status for the DU based on determining whether the received NB cell information matches the previous NB cell information.

Item [9]: The OSS according to Item [8], wherein if the previous NB cell information matches the current NB cell information, the location binding status comprises enabling location binding for the DU.

Item [10]: The OSS according to any one of Items [8]-[9], wherein if the previous NB cell information does not match the current NB cell information, the location binding status comprises disabling location binding for the DU.

Item [11]: The OSS according to any one of Items [8]-[10], wherein if the received MAC address matches the previous MAC address of the DU and at least one of the previous NB cell information or the received NB cell information is empty, the location binding status comprises enabling location binding for the DU.

Item [12]: The OSS according to any one of Items [8]-[11], wherein if the received MAC address does not match the previous MAC address of the DU and only one of the previous NB cell information or the received NB cell information is empty, the location binding status comprises disabling location binding for the DU.

Item [13]: The OSS according to any one of Items [8]-[12], wherein if the received MAC address does not match the previous MAC address of the DU and both the previous NB cell information and the received NB cell information are empty, the location binding status comprises enabling location binding for the DU.

Item [14]: The OSS according to any one of Items [8]-[13], wherein the DU comprises a femtocell.

Item [15]: A non-transitory computer-readable recording medium having recorded thereon instructions executable to perform a method including: receiving, by an operation support system (OSS), a MAC address and neighboring (NB) cell information from a distributed unit (DU); determining, by the OSS, whether the received MAC address matches a previous MAC address of the DU; determining, by the OSS, whether the received NB cell information matches a previous NB cell information of the DU based on determining whether the received MAC address matches the previous MAC address of the DU; and outputting, by the OSS, a location binding status for the DU based on determining whether the received NB cell information matches the previous NB cell information.

Item [16]: The non-transitory computer-readable recording medium to Item [15], wherein if the previous NB cell information matches the current NB cell information, the location binding status includes enabling location binding for the DU.

Item [17]: The non-transitory computer-readable recording medium according to any one of Items [15]-[16], wherein if the previous NB cell information does not match the current NB cell information, the location binding status includes disabling location binding for the DU.

Item [18]: The non-transitory computer-readable recording medium according to any one of Items [15]-[17], wherein if the received MAC address matches the previous MAC address of the DU and at least one of the previous NB cell information or the received NB cell information is empty, the location binding status includes enabling location binding for the DU.

Item [19]: The non-transitory computer-readable recording medium according to any one of Items [15]-[18], wherein if the received MAC address does not match the previous MAC address of the DU and only one of the previous NB cell information or the received NB cell information is empty, the location binding status includes disabling location binding for the DU.

Item [20]: The non-transitory computer-readable recording medium according to any one of Items [15]-[19], wherein if the received MAC address does not match the previous MAC address of the DU and both the previous NB cell information and the received NB cell information are empty, the location binding status includes enabling location binding for the DU.

It will be apparent that within the scope of the appended clauses, the present disclosures may be practiced otherwise than as specifically described herein.

What is claimed is:

1. A method comprising
receiving, by an operation support system (OSS), a MAC address and neighboring (NB) cell information from a distributed unit (DU);
determining, by the OSS, whether the received MAC address matches a previous MAC address of the DU;
determining, by the OSS, whether the received NB cell information matches a previous NB cell information of the DU based on determining whether the received MAC address matches the previous MAC address of the DU; and
outputting, by the OSS, a location binding status for the DU based on determining whether the received NB cell information matches the previous NB cell information.

2. The method as claimed in claim 1, wherein if the previous NB cell information matches the current NB cell information, the location binding status comprises enabling location binding for the DU.

3. The method as claimed in claim 1, wherein if the previous NB cell information does not match the current NB cell information, the location binding status comprises disabling location binding for the DU.

4. The method as claimed in claim 1, wherein if the received MAC address matches the previous MAC address of the DU and at least one of the previous NB cell information or the received NB cell information is empty, the location binding status comprises enabling location binding for the DU.

5. The method as claimed in claim 1, wherein if the received MAC address does not match the previous MAC address of the DU and only one of the previous NB cell information or the received NB cell information is empty, the location binding status comprises disabling location binding for the DU.

6. The method as claimed in claim 1, wherein if the received MAC address does not match the previous MAC address of the DU and both the previous NB cell information and the received NB cell information are empty, the location binding status comprises enabling location binding for the DU.

7. The method as claimed in claim 1, wherein the DU comprises a femtocell.

8. An operation support system (OSS) configured to:
receive a MAC address and neighboring (NB) cell information from a distributed unit (DU);
determine whether the received MAC address matches a previous MAC address of the DU;
determine whether the received NB cell information matches a previous NB cell information of the DU based on determining whether the received MAC address matches the previous MAC address of the DU; and
output a location binding status for the DU based on determining whether the received NB cell information matches the previous NB cell information.

9. The OSS as claimed in claim 8, wherein if the previous NB cell information matches the current NB cell information, the location binding status comprises enabling location binding for the DU.

10. The OSS as claimed in claim 8, wherein if the previous NB cell information does not match the current NB cell information, the location binding status comprises disabling location binding for the DU.

11. The OSS as claimed in claim 8, wherein if the received MAC address matches the previous MAC address of the DU and at least one of the previous NB cell information or the received NB cell information is empty, the location binding status comprises enabling location binding for the DU.

12. The OSS as claimed in claim 8, wherein if the received MAC address does not match the previous MAC address of the DU and only one of the previous NB cell information or the received NB cell information is empty, the location binding status comprises disabling location binding for the DU.

13. The OSS as claimed in claim 8, wherein if the received MAC address does not match the previous MAC address of the DU and both the previous NB cell information and the received NB cell information are empty, the location binding status comprises enabling location binding for the DU.

14. The OSS as claimed in claim 8, wherein the DU comprises a femtocell.

15. A non-transitory computer-readable recording medium having recorded thereon instructions executable to perform a method comprising:
receiving, by an operation support system (OSS), a MAC address and neighboring (NB) cell information from a distributed unit (DU);
determining, by the OSS, whether the received MAC address matches a previous MAC address of the DU;
determining, by the OSS, whether the received NB cell information matches a previous NB cell information of the DU based on determining whether the received MAC address matches the previous MAC address of the DU; and
outputting, by the OSS, a location binding status for the DU based on determining whether the received NB cell information matches the previous NB cell information.

16. The non-transitory computer-readable recording medium as claimed in claim 15, wherein if the previous NB cell information matches the current NB cell information, the location binding status comprises enabling location binding for the DU.

17. The non-transitory computer-readable recording medium as claimed in claim 15, wherein if the previous NB cell information does not match the current NB cell information, the location binding status comprises disabling location binding for the DU.

18. The non-transitory computer-readable recording medium as claimed in claim 15, wherein if the received MAC address matches the previous MAC address of the DU and at least one of the previous NB cell information or the received NB cell information is empty, the location binding status comprises enabling location binding for the DU.

19. The non-transitory computer-readable recording medium as claimed in claim 15, wherein if the received MAC address does not match the previous MAC address of the DU and only one of the previous NB cell information or the received NB cell information is empty, the location binding status comprises disabling location binding for the DU.

20. The non-transitory computer-readable recording medium as claimed in claim 15, wherein if the received MAC address does not match the previous MAC address of the DU and both the previous NB cell information and the received NB cell information are empty, the location binding status comprises enabling location binding for the DU.
